(19) United States
(12) Patent Application Publication
(10) Pub. No.: US 2002/0095231 A1
(43) Pub. Date: Jul. 18, 2002

(54) Online cake design system

(76) Inventors: Xiangdong Yu, Cresskill, NJ (US); Xiangming Yu, (US)

Correspondence Address: XIANGDONG YU, 163 12TH STREET, CRESSKILL, NJ, 07626, US

(21) Appl. No.: 09/812,310

(22) Filed: Mar. 20, 2001

Related U.S. Application Data
(60) Provisional application No. 60/190,675, filed on Mar. 20, 2000.

(51) Int. Cl. G06F 19/00

(52) U.S. Cl. 700/97

(57) ABSTRACT

A distributed software running on computer-driven networks, with client side programs (104) and server side programs (108), which provide a means for cake makers (116) and decoration resource producers (114) from one or more network locations to present decoration resources, such as available colors, materials, pre-designed cake text, icons, fruits, and samples, and a means to enable cake customers (100) from anywhere in the network to design their own cakes using the resources from different providers, and save the design to the servers, so that the appointed cake makers can retrieve the designs from the servers and produce cakes accordingly. The server programs run on network nodes, store copies of client programs, decoration resources, and design results. They communicate with programs in cake makers and resource producers, with client programs that are (implicitly) downloaded and run on customers machines, and with other servers. The client program is a painting applet providing a Graphic User Interface that mimics the process of real cake decoration. It has a “table area” (20), a Cake control group, an Edit-Mode control group (16), optionally including Select, Cake, Knife, String, Cream, Text, Decoration Items, Tracing, an Operation control group (18) which provides further choices for each edit mode (e.g., Decoration mode may have Strawberry, Kiwi, grape, and other items as operation choices. Text mode may have pre-designed text “Happy Birthday”, as well as choices of typefaces), a color pallet, and other controls such as undo/redo. The client program is event-driven and customers' input events are grouped into sessions. There are three major session types: click, drag, and hop, where hop is formed by a sequence of mouse click-move-click-move . . . end with a double-click or drag. Depending on the event targets and locations, sessions of events achieve various drawing effects in the table area (20).

### CROSS-REFERENCE TO RELATED APPLICATION

This application is entitled to the benefit of Provisional Patent Application filed on Mar. 20, 2000, with application No. 60/190,675

A filing to the Document Disclosure Program for this application was made on Mar. 25, 1999, with document number 453684.

### BACKGROUND

1. Field of Invention

This invention relates to Electronic-Commerce through computer driven networks, specifically to the process of designing or customizing cakes for various occasions, by the customers themselves and with connection to cake decoration resources provided by a network of providers (bakeries, party places, and so on).

2. Description of Prior Art

There are various occasions in life when people would like to have well decorated cakes, such as birthday parties, wedding ceremonies, corporate events, greetings, etc.

People normally order pre-designed cakes, on spot, by phone/fax, or (started recently) through the Internet. The decoration choices have been limited to a small collection of traditional patterns, and to the available coverings and decoration items made by manufacturers such as Edible Image™. Cake “customization” has been understood as a few selections from a number of lists.

A patented printing technology that can put images to edible paper recently appear in the market. Such printers can take certain types of images customers have uploaded through the Internet, output them to edible media which is then covered to cakes.

There have been various image producing and editing programs running on different computer systems and with different kinds of functionality.

This complete-looking chain of technologies, however, misses an important link.

It does not enable a customer to design his or her own cake with convenient access to decoration resources of cake makers. And it does not provide an intuitive and uniform cake design tool that can be used from different locations.

(a) Pre-designed cake patterns and coverings available in the bakeries may not meet the special need of the particular customer for a particular event.

(b) Customer may fail to find a proper image to upload from his or her own computer or from other image sources.

(c) Customer may prefer to having a hand-made decoration. This may be due to a few reasons: A hand drawn (cream or icing) line is “3D”, while printed media only has a “flat face”. A cake master can make certain improvements on a not-so-perfect design, while a printer can only copy as is. To make it easy for cake master to implement a design, design program must contain a right collection of features that mimic cake master's operations instead of being a general purpose image editor.

(d) Existing drawing/painting programs are not readily connected to the decoration resources available from cake-makers.

(e) Children form a large group of fancy cake consumers. Just picking a known image for a cake does make full use of the opportunity that should have been more educating and entertaining.

(f) The customer may often be away from his or her familiar drawing/painting programs (e.g., travel away and want to send a cake to a family member). Out of cake industry, there are a number of known prior arts of online graphic design program. One is the Java applet used in http://www.garden.com, with which one can design one's own garden by drawing plants from a palette. It does not have drawing capability other than placing icons into the garden area. Another drawing applet can be found in http://artsafari.moma.org/, it has more drawing capability than the garden one, but did not work well when we play with it on Mar. 10, 1999 (it was submitted to Java World online magazine around Feb. 10, 1999). It was designed to let children learn to draw by following famous paintings. There are more Java drawing programs. Due to lack of good graphics support in early Java versions, few were known to have entered into public use like the above two. To our best knowledge, none of them apply online drawing technology to cake customization, and their drawing interface and operations are not tailored for cake design. There exist many E-Commerce sites on the internet. Their functionality is usually limited to the sites themselves. For example, they may only be able to refer to merchandizes registered with the sites. In our system, however, drawing programs from different servers may share resources such as decoration collections.

### SUMMARY

In accordance with the present invention, an online cake design system comprises a drawing/painting program that is tailored to mimic the decorating procedure of a cake master, that can be run (after an implicit or explicit download procedure, if necessary) from any computer connecting to the network, that is linked to the decoration resources on cake makers' computers and to other sources on the network so that a designer can freely apply them to the cake design, and that is easy to use and small enough for quick download without losing features such as lines, shapes, colors, images, text, fill, select, copy, flip, rotate, trace, undo/redo, and others that are necessary to support cake designers of all ages and different skills.

The invention further comprises mechanism for cake makers/decorators to provide data of decoration items to the network, so that the design program can present this data for customer to use. Factors such as availability, prices, tastes, materials, etc are taken into account before the items are presented to customer.

Objects and Advantages

Accordingly, the present invention has the following objects and advantages:

(a) The customer is able to customize graphically cake maker's designs to his or her own need.

(b) The customer is able to create his or her own design with components from his or her brain, from other images sources he or she knows, as well as from bakeries' sites.

(c) The customer design can entirely consists of hand drawing (lines and shapes) and pre-made decoration items in a bakery. It is much easier for the bakery to implement such design in “3D” fashion than those photo-style images usually uploaded.

(d) The design program in the invention is easy to learn and use, without compromising its power. This is important since a customer would not be willing to spend too long to learn skills just for designing a cake. It is not realistic either to expect that a customer would remember the skills for use next time. On the other hand, the program must be powerful enough in providing drawing/painting features such as lines, shapes, colors, images, text, fill, select, copy, flip, rotate, trace, undo/redo, and others that are necessary to accomplish the job comfortably for cake designers of all ages and different skills, especially for children.

(e) The design program in present invention can be easily and quickly loaded and run from any connected computer, no matter it is at one's home, in a hotel lounge, or in an airport waiting area, as long as it has a pointing device and a screen not too small to hold a “cake”.

(f) The cake makers or decorators can easily provide and update data of their available decoration items to the network. This data tells customers about prices, tastes, materials, and so on.

Further objects and advantages of the invention will become apparent from a consideration of the drawings and ensuing description.

### DRAWING FIGURES

In the drawings, closely related figures have the same number but different alphabetic suffixes.

FIG. 1 shows an overview on how the full system is put in use.

FIG. 2 shows the components involved in more detail as focused on one pair of customer and cakemaker, and optionally a third party decoration resource producer.

FIG. 3 shows the major user interface of the client side design program.

FIG. 4 shows the data and code pieces and logic flows among them in the client side design program.

FIG. 5 shows the data and code pieces and logic flows among them in the server side program.

### DESCRIPTION

Main Embodiment

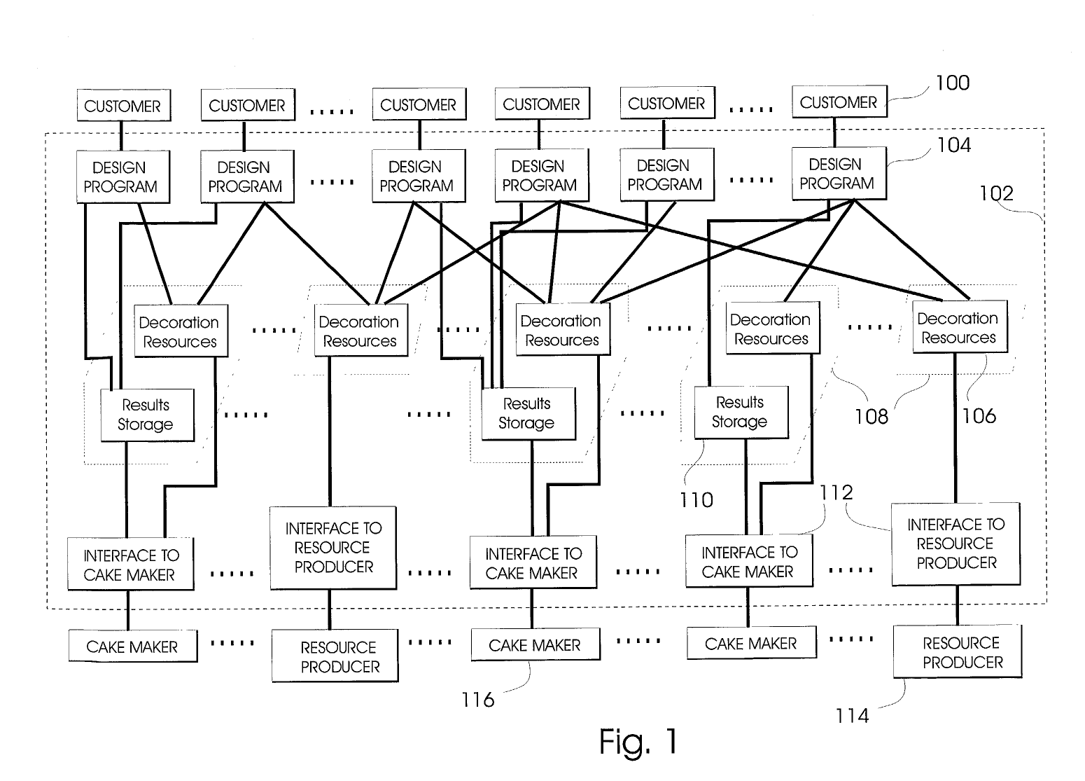

As shown in FIG. 1, the invented system is based on a computer driven network 102 such as the Internet. Customers 100 refer to any people who would like to create a cake design, no matter for cake order(s) coming next or for pure entertainment. Customers 100 start the client side design program 104 on computers in network 102. Before start, the program 104 may need to be downloaded from a server, unless it has been downloaded before and still usable. The download step can be (and typically are) implicit, as in the case of Java Applet in Internet browser. All customers 100 see is that the program 104 is “starting”. This is in contrast to traditional programs that require explicit steps of download and installation before running.

Decoration resources 106 refer to icons and images of physical items that can be put on cakes, such as icing flowers, fruits, cartoons, pre-made cake designs, and so on. During the designing, customers 100 can freely use decoration resources 106 stored on the servers 108. The intermediate and final design results 110 can also be saved to the servers 108.

On the other side, cake-makers 116 and decoration resource provider 114 can update resources 106 onto servers 108 through interfaces 112, which can be present on any computers in network 102. For example, on the Internet, web pages can serve as such interfaces. Through interface 112, cake-makers can retrieve design results 110 and physically produce cakes based on the designs.

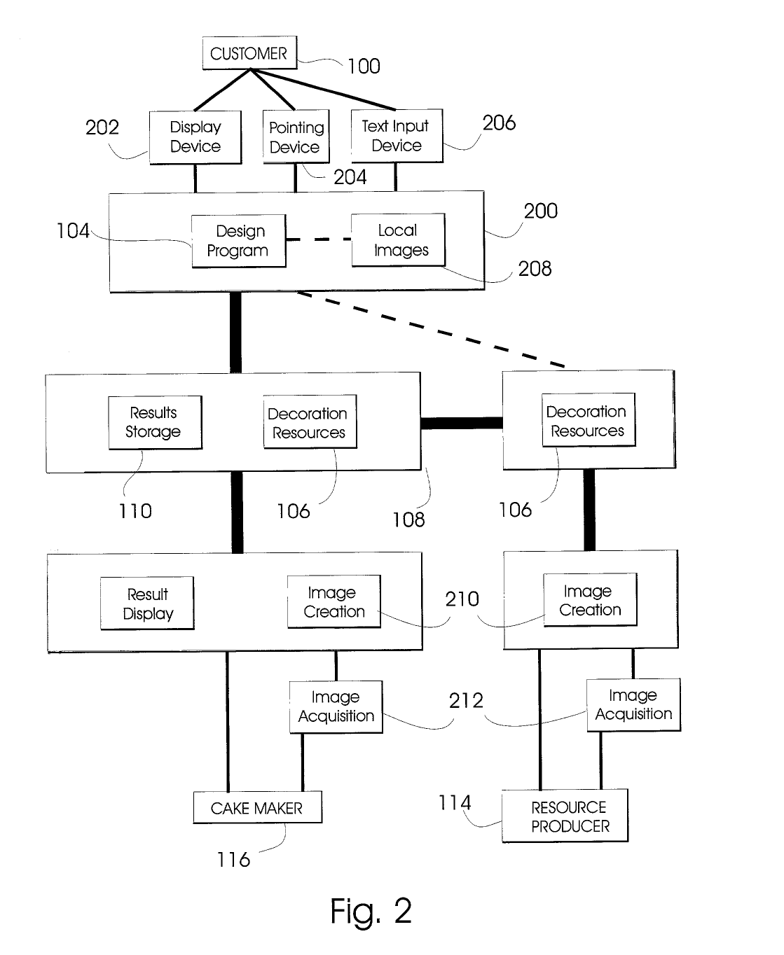

FIG. 2 focuses on one client-server combination, including customer 100, cake-maker 116, and optionally resource provider 114. Client side computer 200 is required to be equipped with display device 202 such as monitor and pointing device 204 such as mouse or pressure-sensitive screen. Text device 206 is necessary only if customer 100 would enter text (instead of drawing text or pick choices). In addition to decoration resources 106 on cake-maker's server 108, local images 208 and resources 106 from provider 114 can be applied to design. Cake-maker 116 and resource provider 114 produce resources using image creation programs 210 and image acquisition programs 212 on their own computers and upload resources to the servers.

An important note on the way design program 104 gets resources is, due to security reason, design program 104 may not be able to directly communicate with any computers other than its starting server 108. In this case, resource requests to other computers such as provider's server and even customer's own computer 200 must be fulfilled indirectly through starting server 108. I.e., a request including target address is first sent to server 108, then server 108 redirects the request to the true target, the target in turn sends back a response to server 108, and at last server 108 passes the response to design program 200.

Design result 110 can be presented to cake-maker 116 in one or more of existing channels. For example, on the Internet, web pages and emails can serve as such channels. In addtion, design result 110 can also be presented to interesting parties other than cake-maker 110 using the same mechanism.

Design program 104 is essentially a drawing/painting program. There have been many graphic design programs in the world. It is not the purpose of the current invention to devise any new drawing algorithms or create any new special effects. On the contrary, it is our purpose to select a good SUBSET of existing graphic functions to fit the special needs of cake design on the network. The subset of functions must be powerful enough so that it is not awkward to finish normal design tasks. On the other hand, it will take some time for the system resources in customers' computers to grow, for network bandwidth to grow, and for the capabilities of related software packages to grow. Hence, this subset of functions must start small and grow in time. Besides, since customers are not frequent or professional users, program 104 cannot go arbitrarily sophisticated. In the description below, we focus on high level selection and organization of the functions, and leave out implementation details which can be filled by any average programmers given all the existing graphic programs and publications. If we think a big feature is good to have, but can be omitted in the case of tight system resources and network bandwidth, we will point it out.

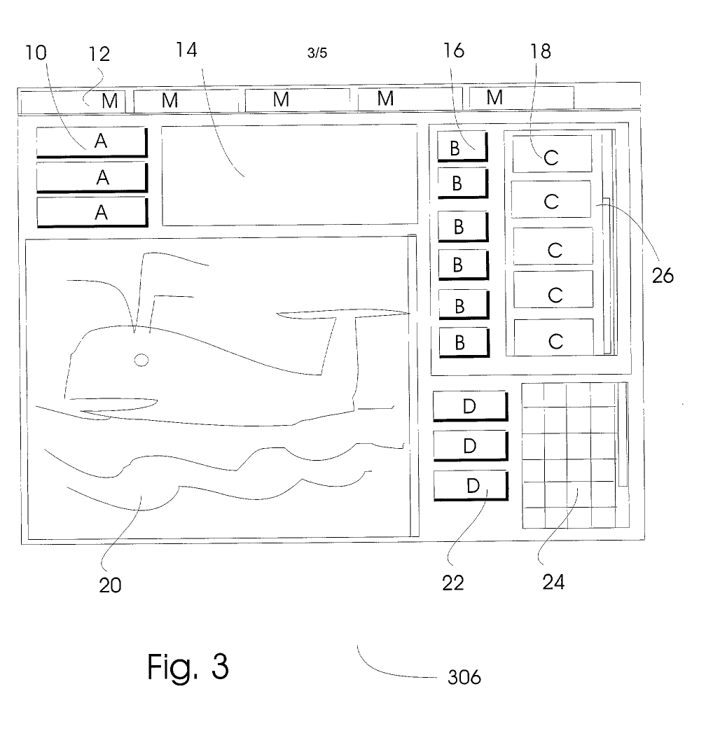

FIG. 3 shows a typical layout of graphic user interface (GUI) 306 for design program 104. It comprises an drawing area 20 (we can think of it as corresponding to a physical work “table” in cake-maker's workshop) in which the shape and image of the cake are manipulated. Around the table area 20 are groups of controls and text/icons. We can divide the controls and text/icons into the following groups:

(List: GROUPS of CONTROLS and TEXT/ICONS)

1. Cake control group, including controls for creating new cake design, specifying cake parameters (such as size, layer materials, siding, rim, and so on), open existing design, save design to old or new location, send design by email, convert the design to various representation formats, etc.

2. View group, allow customer to examine design in 2D, 3D, and Multi-piece view.

3. Edit mode group 16, including Select, Cake, Knife, String, Cream, Text, Decoration, Tracing, Highlighter, and Assembly. Each control must work with another group of Choices of Operations 18 as described below:

3.1. Select. Choices of shapes in which an area (or object(s) it indicates) in the image can be selected, including Point, Rectangle, Oval, Polygon, Color(to select an area of the same or similar color), and so on; and operations on selected area such as Move, Copy, Rotate, Flip, Scale, Stretch, Fill and other filtering operations.

3.2. Cake. Choices of shapes in which new “flesh” of cake is added/overlapped to table. These shapes are usually simple rectangle or oval. In addition, by choosing a particular color in this mode, all the pixels in the image with that color will be replaced with raw cake material, equivalent to a selective reset.

Selective reset allows customer to sketch with one spare color and then erase all the sketch lines after the picture is done.

3.3. Knife. Choices of shapes for cutting cakes, including straight line, curve, rectangle, oval, polygon. This mode is the opposite of Cake mode. Similarly, by choosing a particular color in this mode, all the pixels in the image with that color will be cut off.

3.4. String. Choices of lines, differing by thickness and style. User may have the flexibility of choosing which color and material to be used in drawing lines.

3.5. Cream. Choices of lines (thick) and shapes (similar to those for Select) that can be spread out with cream, icing, or other face material. Different colors can be selected for the material.

3.6. Text. Choices of typeface and styles. Different colors can be selected.

3.7. Decoration. Choices of objects from decoration resources 18, including

Flowers—Natural and Artificial;

Fruits—Strawberry, Kiwi, Pineapple, Banana, Blueberry, and so on;

Sweets—Candy sticks or grains, Chocolates, and so on;

Cartoon Figures—Dinosaur, Bear, and so on;

Siding—Decoration items or pattern along the rim or side of the cake;

other pre-built edible pictures and patterns.

3.8. Tracing. Allow customers, especially those with little drawing skills, to trace model image(s), or simply copy part or all of the model image(s), and insert the result(s) into the cake design. Model image(s) can come from any accessible image sources in the network, including the decoration resources in cake-makers' server and resource producers' server 108. The difference between “decoration objects” and “model images” is meaningful only when the design is implemented to a cake: the former have corresponding physical items and can be directly added on by cake-makers, while the latter may be just images and require some sort of “copying-to-cake” procedure.

Choices of operations in this mode include Address, Move-and-Insert, Lines, and Region. Operation Address allows customer to specify the addresses of the model images, which is normally a text string to be entered in a text field. Alternatively, customers can browse image collections and select with pointing device. They can further trigger a GUI control such as a button to let design program randomly pick model images from a given category. After obtaining a model image, customer can move and resize it properly.

Operation Lines turns on the real tracing, using lines of various thickness and colors. To make traced lines outstanding from the model image, customer can choose to show the model image in original colors, show in XOR'ed colors, or hide it.

Operation Region is for copy part or all of the model images.

Operation Move-and-Insert allows customer to move the traced or copied result to appropriate position(s) and insert into the cake design.

3.9. Highlighter. Provide customers a tool for “special” effects. Typical effect is 3D look. Assuming a direction of light source (say, from upper-left), the user can highlight certain points, lines and areas to indicate what kind of 3D look is expected. This method is better than usual perspective view since the latter is kind of hard to handle for non-professional users, and unnecessary for our particular needs.

Choices of operations include Point and Lines, corresponding to spot highlight and edge highlight.

3.10. Assembly. Allow users to assemble multiple pieces of cakes into a 3D structure, such as a wedding cake stack.

Choices of operations include Top-Down Section, East-West Section, and North-South Section, allow customer to specify layers of cake and components and layout of each layer.

4. Session group. Associated to individual mode-operation combinations. A common component is a help area (text/icons) that shows a short hint about what moves to make under current circumstance. Other session controls become visible only under the specific circumstances they are applicable. These controls include:

4.1. For Select. Controls for Flip, Rotate, and other operations on selected region. For example, the control for Flip can be a selection list including item “No Flip”, “Vertical”, and “Horizontal”. Rotate control can be one or two selection lists for degrees. Alternatively they can be done with images button.

4.2. For Text. A text field to enter text, or a character picker.

4.3. For Decoration. Flip and Rotate controls.

4.4. For Tracing. Operation Address requires a text field to enter address. It also requires controls for browsing and randomly picking model images. If necessary, a separate window can be popped up to facilitate this process. Besides, this operation needs a resize control to enter or pick the resize ratios for model images.

Operation Lines needs a control to switch between hide and show modes of model.

Operation Region requires a copy button.

Operation Move-and-Insert requires an insert button.

4.5. For Assembly. A selection control lists all components. A selection control lists section positions (e.g., in Operation Top-Down Section, this control tells which layer is being shown). An Add and a Delete button.

5. Color group. A color palette. Working with Edit modes. It has two sections. The top section contains frequently used cake decoration colors. The other section covers more colors in the spectrum. For example, the 216 standard colors used for Netscape web browser.

Color is just one kind of “Filling Material”. If system resource and network bandwidth is not a concern, other fill materials can be introduced, such as gradient, pattern, texture, etc.

6. Reverse group. Undo or Redo completed or partially completed operations. Cancel partial operations.

A related group of controls may be arranged in a container, which may have scrollbar(s) if the group is too large. Containers as well as controls can be hidden/removed when not needed.

In addition to main GUI window 306 described above, design program may pop up other windows:

(List: ADDITIONAL WINDOWS)

1. Help Info Boxes. Windows containing (fixed or context sensitive) help information. This is necessary because most customers are unprofessional and infrequent users of the program.

2. User Dialog Boxes. Modal windows to show warning or status messages, also for customer to enter text. They may contain buttons like Ok, Cancel, Yes, No.

3. Draw Sequence Window. For replaying and manipulating the sequence of drawing operations of current or previously designed cakes. This is intended for advanced users, who may do things like combining parts from multiple cake images, removing or relocating segments from current drawing sequence. It is essentially a text editor handling a sequence of drawing commands. A Replay button triggers the commands to be replayed to the “table area” 20.

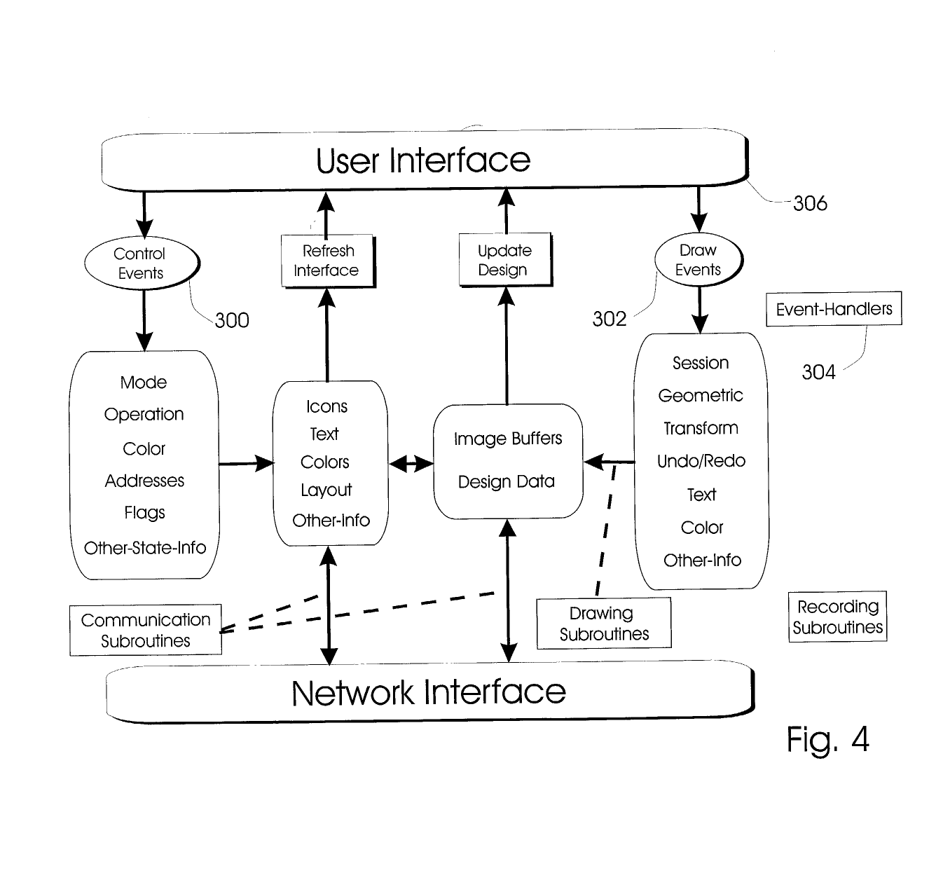

FIG. 4 shows the “Engine” part of design program 104. It works on event-driven model. From customer, there are two major event types: Control Events 300 and Draw Events 302, roughly representing events originating from the controls around table area 20 and those from table area 20 itself, respectively. Based on the event received, Event handler 304 calls appropriate subroutines to modify appropriate data entities and update GUI 306.

The core data entities are design image itself. Design image is represented in a layer-and-object structure. It may consists of a number of layers, while each layer may contains a number of objects, which can be vector-represented shapes or bitmap images. The final image is the result of rendering all layers bottom-up. The advantage of objects is that they can be selected and manipulated individually, such as move and rotate. It also helps in identifying which material or decoration is picked from the bakery's collection. Without using object, this identification, if necessary, may be achieved by using “Alpha-Channel”, by out-of-image comments, or simply by cake maker's judgement.

Bitmaps are stored in image buffers. One example of image buffer is Java's Image class. The major component of an image buffer is a pixel matrix. To support an anti-flickering technique called “double buffering”, drawing primitives must be made applicable both to “screen” and to image buffers. Image buffers can in turn be drawn to the screen.

Objects are maintained in object list, one for each layer. They will be painted to an image buffer in bottom-up order. Each object has a vector or bitmap representation. It has a method called IS_AT. Given a position, this function tells if this position is at this object. It is used to determine if this object is selected by a particular select action. Objects are ordered. To the user's view, one may be in front of another (i.e., in an upper position). This order is not only used in rendering, but also used in selecting. In rendering, as stated above, objects in the back are drawn first. In selecting by click, the most front object with IS_AT(click position) equal to true is selected. By default, a newly introduced object is the most front one in current layer.

More complete information about data entities handled by design program is as follows,

(List: Data Entities)

1. State Data Entities. Include

crnt_mode, prev_mode;

crnt_operation, prev_operation;

crnt_color, prev_color;

in_session;

crntlayer, crnt_object, crnt_keyboard_focus, and their prev_. . .

Other state data.

1. Geometric Data Entities. Include

crnt_x, crnt_y, prev_x, prev_y;

data for selected region;

degree of rotation, direction of flip, ratio of resize, etc.

Other geometric data.

2. Design Data Entities. Include

Images buffers for on-going session, for previous session(s), for model image, for tracing result, and some auxiliary buffers. To reduce system resource usage, one buffer may serve multiple purposes. In a very simple setting using very little system resources, it suffices to have a master image buffer, a reverse image buffer, and optionally a volatile image buffer. Master buffer is usually what's displayed in the image area. Before a session starts, the contents of master buffer is copied to reverse buffer, and all the subsequent partial drawing happens to master buffer. In a simple undo scheme, reverse action will swap the role of master and reverse buffers. Volatile buffer is used to draw temporary contents such as image cursor, auxiliary lines, and so on, with master buffer as background. In this case, the displayed image will be contents of volatile buffer. Every time the temporary contents change, master buffer is copied to volatile buffer, followed by drawing of the temporary contents, which is in turn followed by rendering of volatile buffer to the screen. Without volatile buffer, these temporary contents can be directly rendered to the screen, causing some flickering (fortunately, most temporary contents are small).

Volatile buffer can also be used as temporary storage of filtering operations.

Additional reverse buffers would enable multiple undo steps. Otherwise, this would have to be implemented in a more roundabout way using recorded actions.

Action recording. Tracks actions that have happened to this design. May be used to playback the design. Is editable by customer. May be organized in timely ordered actions or in hierarchically grouped objects.

Cake parameters such as size, siding, rim, and layer materials.

Other image data.

3. Network Data Entities. Include

Addresses of decoration resources.

Addresses of storage locations.

Other network data.

Customer generates raw input events through input devices such as pointing device 204 and text input device 206. Event handler 304 processes these events and convert them to abstract input events. For example, when customer clicks a button corresponding to Editing mode “String”, the raw event of “mouse click at the button” is translated into an abstract event “Enter Mode String”. With this level of abstraction, design program 104 gets flexibility in GUI layout. I.e., GUI can be customized/redesigned so that the same “Enter Mode String” event is triggered in some other way, say, by customer's selection from a list. In program, this abstraction is implemented by clearly identifying code pieces to be called upon each abstract event. Event handler 304 calls these code pieces upon corresponding raw event(s).

Below we describe the handling of abstract events. We will also point out the raw event(s) that typically result in the abstract ones.

(List: Groups of Events)

1. Enter-Mode Events.

There is one such event for each of the Editing Mode described above. Customer is requesting design program 104 to switch into the mode associated to this event.

They are triggered when customer clicks at buttons in group 16.

In response, design program first finishes certain clean-up tasks, if any, for previous mode. Then updates internal variables needed for the switch. And finally refreshes GUI to show the appearance matching the new mode. More concretely,

1.1. The clean-up tasks include, finalize editing done in previous Session (see below).

1.2. Related internal variables include,

1.2.1.crnt mode; //current mode

1.2.2.prev_mode; //previous mode

1.2.3.crnt_op; //current operation (see below)

1.2.4.prev_op; //previous operation (see below)

Since operations are associated to modes, mode switching must cause operation switching. When entering a mode, the operation is switched to the one when exiting from the same mode last time. Or, if it is the first time in this mode, the operation is set to a default one in the group.

1.3. Refreshing GUI usually means showing the triggering control(s) for this mode in proper visual form, such as a pushed down button, and the rest controls in group 16 in normal form, such as un-pushed buttons. The operation group 18 associated to previous mode is removed/hidden from operation container 26, and the operation group associated to current mode is added in or made visible. Similarly, the session control group associated to the operation in previous mode is replaced with that for the operation in current mode.

2. Enter-Operation Events.

Given mode, there is one such event for each Choice of Operations associated to the mode. Customer is requesting design program 104 to switch into the operation associated to this event. They are triggered when customer clicks at icons in the operation group 18 which is held in container 26.

In response, design program first finishes certain clean-up tasks, if any, for previous operation. Then updates internal variables needed for the switch. And finally refreshes GUI to show the appearance matching the new operation. More concretely,

2.1. The clean-up tasks include, finalize editing done in previous Session (see below).

2.2. Related internal variables include,

2.2.1.crnt_op; //current operation

2.2.2.prev_op; //previous operation

2.3. Refreshing GUI usually means showing the triggering control(s) for this operation in proper visual form, such as an icon with a frame, and the rest controls in group 18 in normal form, such as un-framed icons. In addition, the session control group associated to the previous operation is replaced with that for the current operation.

3. Pick-Color Events.

There is one Pick-Color event associated to each color in palette 24. Usually one such event means that customer wants to change the color to be applied in following drawing Sessions (see below). In certain mode-operation circumstances, a Pick-Color event may itself result in changes in the design. For example, in Cake mode and Knife mode, a Pick-Color event means to fill all spots in design image that have the event's associated color with cake material or with table background (cut off), respectively.

Pick-Color events are triggered when customer clicks at color cells in palette 24. The associated color to an event is the one in the clicked cell.

In response, design program first finishes certain clean-up tasks, if any, for previous color. Then updates internal variables needed for the switch. And finally refreshes GUI to show the appearance matching the new color. More concretely,

3.1. The clean-up tasks include, finalize editing done in previous Session (see below).

3.2. Related internal variables include,

3.2.1.crnt_color; //current operation

3.2.2.prev_color; //previous operation

3.3. Refreshing GUI usually means showing the triggering control(s) for this operation in proper visual form, such as a color cell with a frame, and the rest controls in palette 24 in normal form, such as un-framed color cell.

4. Draw Events

Refer to a group of events that lead to direct changes in table area 20. They are mostly initiated from customer's action in this area.

Draw Events work in Session. A session consists of a single or a sequence of draw events. The result of a session is usually a graphic unit in the design image: a point, a line or trail, a shape, and so on. It may also be an auxiliary visual action, such as moving a graphic entity from one location to another, or somehow transforming the entity.

4.1. Point-Press Event, Point-Drag Event, Point-Release Event, and Point-Move Event are abstract events that often work together in a session.

Point-Press is typically generated when customer presses down a mouse button, or press at a point in a pressure sensitive screen. It carries such information as the coordinate of the pressing point, and the time when the pressing happens.

Point-Release is the same as Point-Press, except that it is corresponding to customer's action of lift the button or finger pressed before.

Point-Drags are typically generated when customer moves the “cursor” of the pointing device in “Pressed” condition. One such event is corresponding to a very small step in the move. It carries such information as the coordinates of the starting point and ending point of this step, and its starting (or ending time).

Point-Move is the same as Point-Drag except that it happened when the pointing device is in “Released” condition.

4.2. Point-Click Event and Point-Double-Click Event are “synthetic” events derived from Point-Press and Point-Release.

A Point-Click event is generated when a Point-Release follows a Point-Press without any event in between.

A Point-Double-Click event is generated if two Point-Clicks happen within a short (can be specified by parameter) time interval without any event in between.

4.3. A Click Session consists of one Point-Click.

4.4. A Double-Click Session consists of one Point-Double-Click.

4.5. A Drag Session consists of a Point-Press, a sequence of Point-Drags, and a Point-Release.

4.6. A Hop Session consists of (repeated) pair(s) of a Point-Click plus a sequence of Point-Move, and a terminating Point-Double-Click or Point-Drag.

4.7. A Move Session consists of a sequence of Point-Moves.

4.8. The above 5 session types form the basic set of actions needed to design cake comfortably. They require only a pointing device with a single press button. In the case of pressure sensitive screen, one finger of customer will do. This is a basis for the invention's advantage of easy to learn and use.

4.9. Transformation Events.

Include Scale Event, Flip Event, Rotate Event, and so on. These events normally constitute single-event sessions. Although the same functionality may be achieved with basic sessions above, it is sometimes more convenient or more accurate to do it through a control outside table area 20. For example, customer can click an icon in a session control group to instruct flip horizontally or vertically. And customer can select the exact degree to rotate from a list. Further, customer can enter a number in a text field to indicate scaling percentage.

4.10. Text Events

Case I: Address Events. Customer enters the address of a decoration resource to a text field, and ask for it by hitting RETURN key or press a button. One such event carries such information as the text string for the address.

Case II: Message Events. Customer enters a message such as “Happy Birthday” to be added to the design image.

Text Events are not necessarily part of a session. Design program handles them by storing the text information in proper variable(s) to be used in later session(s). Since they may not directly change design image, they can be categorized as Control Events instead of Draw Events.

4.11. Trace Events

These events are related to tracing a model image. They are typically triggered when customer press corresponding buttons. During tracing, a model image, if any, is placed in a model image buffer. And tracing result is placed in a tracing image buffer. Tracing result can be inserted to design image which is stored in yet another buffer.

Random-Model Event: Randomly pick an image (from certain category) and show it as model.

Copy-Model Event: To copy part (if a region has been selected) or all of the model image to tracing buffer.

Show Image, Contrast Image, Hide Image Events: Control the display of the model image—Show as is, show in contrast (XOR'ed) color, or hide.

Clear-Trace Event: Clear tracing buffer.

Insert-Trace Event: To insert the traced or copied result in the tracing buffer to design image.

Trace Events form single event sessions.

4.12. Session

It has been mentioned above when event(s) can form sessions. Below we describe in more detail on how session works in cake design.

Under any given mode-operation circumstance, it is made clear which sessions are expected and what to do in each type of session. Sessions are exclusive, no session is expected if it is already in a session. When the first event(s) in a session is received, a subroutine session_start is called. Note that sometimes it takes more than one events to determine which session to start. For example, a Point-Press may lead to either a Point-Click or a Point-Drag, the session is not determined until next event—a Point-Drag implies a Drag session and a Point-Release implies a Click session. In some situation, one session type may be a “prefix” of another session type. For example, Click session vs. Double-Click session. Design program can either delay processing Click session a short period to distinguish from Double-Click session, or, make the actions of these two sessions compatible, so that it is ok to inherit the effect of a previous click when handling the second click in a Double-Click session. Subroutine session_start is passed with current session type, and any event data such as coordinate(s), text string, etc.

If it is a multiple-event session, design program will wait for coming events. When a new intermediate event is received, a session_update subroutine is called. Depending on the event type, it may be an update_point, update_point_pair, and so on. Event data are passed into these subroutines.

Upon receiving an ending event of current session, subroutine session_end is called with event data.

All drawings in the session were done to an active data structure including image buffer(s) and other variables. For the purpose of Undo, the changes are not immediately merged into more permanent data structure. That will be done through subroutine session_finalize upon next Enter-Mode, Enter-Operation, Pick-Color, Session Start, and other events that may need the active data structure to take new changes.

5. Reverse Events.

Undo Event: Customer does not want the changes made in the session(s) just happened. This event is triggered when Undo button is pressed, or Undo menu item is selected. The contents of the active data structure is replaced with a set of contents stored in more permanent data structure. The number of undoable steps depends on how much system resource is to be consumed. Typically one step undo is enough. The data swapped away from the active data structure is not discarded immediately, since they may be needed in Redo. They are discarded if the next action is not Redo.

Redo. Customer wants back the step(s) just undone. This event is triggered by Redo button or menu item. If undo is done by tracking backward in history data structure, redo will be done by tracking forward in the structure.

Cancel. Triggered in the middle of a session by Cancel button. Means terminate the session and undo it.

6. Cake Events

Refresh Event. Triggered by Refresh button or menu item. Customer wants to erase all changes and start over.

Open Event. Load an existing design into the active data structure. The existing design is stored somewhere in the network, most likely the same server where the program is starting from. Customer is given a chance to enter its address or browse it.

Save Event. Store the design somewhere in the network, most likely the same server where the program is starting from. Customer may be given a chance to enter or browse a storage location, or alternatively the program automatically generate an address.

Cake Parameter Events. Including Size, Siding, Rim, Layer Materials, etc. Triggered when customer make selections from lists. They are passed with design to cake-makers. Cake Size plays a role in design stage: the decoration items must be scaled properly according to cake size before being put into design image. Consequently, choosing a new cake size implies refreshing the design.

7. View Events

View-2D Event. 2D view is the default view. It is also the working view when customer design face images. Triggered by selecting from a list.

View-3D Event. Customer wants to have a look at the resulting cake, combining face images, siding, rim, and so on. Like for Drawing Events, “Sessions” can be introduced after this event. In a view session, no changes are made to the design. Instead, view point is adjusted, such as zoom and change viewing angle.

View-Piece Events. In the case of multi-piece cake such as one for wedding, customer can choose to view individual pieces or view the whole stack.

8. Miscellaneous Events

Help Events. Triggered by help button or menu item. Customer wants to get help. In response, design program can show general help as well as context-sensitive (according to current mode, operation, session, etc) help.

Communication Events. Customer wants to communicate the starting server or other network computers, such as making comments and email images. The Address Events mentioned above is also a kind of communication events. Design program calls appropriate network subroutines to finish the tasks.

In response to the events described above, design program will eventually call certain primitive subroutines. Their implementation depends on the computer language and packages used. They have been used in many existing programs. Except for certain special cases, we list them without explanation.

(List Contents Primitives)

1. Lines and Shapes, of various thickness and styles. Lines can be simply a sequence of straight segments, or of some analytic form such as Bezier curves. Shapes can be filled with color, pattern, texture, etc.

2. Image, rendered as is, filtered, or scaled.

3. Transformation, rotate, flip, stretch, etc.

4. Text, added to certain location, with certain font, size, color, style, etc.

5. Object handling, such as select, add, delete, duplicate, move, etc. The result of a session can either be object(s), or change(s) made directly to a “background” image. The primitives mentioned above can apply to both cases. Objects are floating over the background image and can be handled independent of the background. Object feature provides more flexibility, but requires more system resources and customer's skills. In an environment where system resource and network bandwidth is tight, this feature can be dropped from design program. Similar effects can be achieved through selecting and manipulating regions.

6. Other drawing primitives.

(List Communication Primitives)

1. Read, certain type and amount of data from certain address.

2. Write, certain type and amount of data to certain address.

3. Browse, directories in the network.

(List Miscellaneous Primitives)

1. Parse text file in certain format.

2. Generate random number or pick random entry.

With above introduction to events and primitives, we can explain more on what will happen in sessions. Actions in sessions are circumstance specific. However, there do exist some guidelines.

In many circumstances, some sessions have no effect at all. In the case they do have effects, here is what usually to happen:

A Click-Session normally means selecting an object, a location, or an area without any modification. But in “Fill” circumstance, the selected target will be filled with crnt_color (or other filling material).

A Double-Click-Session usually triggers a point-oriented action, such as dropping a decoration item at that location,

A Drag-Session can be used to draw a line (straight or curved, including to deploy decoration items along the line), to draw a standard shape or object (rectangle, oval, text, etc), to move something from place to place, to specify angle and quantity of a transformation, to indicate direction of a gradient fill, and so on.

A Hop-Session can be used to draw a line or polygonal shapes. As compared to Drag-Session, it is especially useful when drawing a fine-tuned target. This is because, customer can see the would-be new point when the cursor is moving, it is not added into the design until next Point-Click, by then customer must have been satisfied with the looking. On the contrary, in Drag-Session, the whole trail of cursor is recorded in design image, even if a Drag is by mistake due to, say, an unsmooth mouse.

A Move-Session rarely has any effect to the design. It is usually used to show an icon that moves with the cursor. For example, the image of a decoration item can move with the cursor, so that it is clear to customer where is the appropriate location to drop it.

Other single event session such as Horizontal-Flip, Resize-to-Ratio, Rotate-to-Degree, Copy-Model-Image, Hide-Model-Image, Insert-Traced-Result, and so on, usually have straightforward meanings.

All actions in sessions will be recorded to action recording data structure.

With these guidelines, it is easy to figure out what will happen in sessions under various circumstances:

(List Session Actions)

1. In all circumstances,

Handle single event sessions triggered from related controls outside table area 20.

2. In Operation Lines in any mode,

Handle Drag-Session and Hop-Session.

3. In Operation standard shapes (such as rectangle, oval, and others that can be defined by two points) in any mode,

Handle Drag-Session.

4. In Operation polygonal shapes (that requires more than two points to define) in any mode,

Handle Hop-Session.

5. In Operation Move, Copy, and Gradient Fill in Mode Select,

Handle Drag-Session.

6. In Operation (Non-gradient) Fill in Mode Select and Cream,

Handle Click-Session.

7. In Operation By-Color in Mode Select,

Handle Click-Session.

8. In Mode Text,

Handle Drag-Session and Click-Session. Although customer can click at a location and enter text, he or she can enter text in a separate text field and then drag in the table area 20. The text will resize and relocate as cursor moves, and added into design after session ends.

9. In Mode Decoration,

Handle Double-Click-Session and Drag-Session. Different items may have different behaviors in Drag-Session. Some items are resizable, Drag-Session will define their final size. While others are not resizable, and Drag-Session will drop them along a line. To avoid overcrowdness, the next drop will not be done until sufficiently far away from the previous one.

Handle Move-Session.

10. In Operation Address and Move-to-Insert in Mode Trace,

Handle Drag-Session. For Address, the model image is moved. For Move-to-Insert, the traced result is moved.

11. In Mode Assemble,

Handle Drag-Session.

12. In View-3D,

Handle Drag-Session

From what we have presented so far, it should be clear that once set up, how design program 104 support customer's design actions. Next we describe how to set up/initialize the program, how to clean up and terminate it, and how to load and save data.

During start up, design program loads certain configuration and interface data from the starting server, including geometric data, icons/images, text strings, addresses, and business data. It initializes to a default design state that is convenient for a naïve customer to get started. We think Mode String, Operation Line X (meaning line with width X), and Color Red is a good start. Action recording data structure is initialized to be empty. Necessary image buffers are created. So on and so forth.

There are two ways to Open/Load an existing design: load the final design image and load the action recording then play back. The former is simpler and use less resources.

Similarly, there are two ways to Save a design: save the final image and save the action recording. In the former case, certain image format conversion may be necessary. In the later case, the recording must be converted to certain storage format, such as drawing command sequence in text.

If customer wants to exit, program 104 will prompt him or her if necessary, with any unsaved work, and certain business data such as the prices of special decoration items, etc. Then design program 104 will turn control to other processes such as order a cake based on the design or email the design to other people.

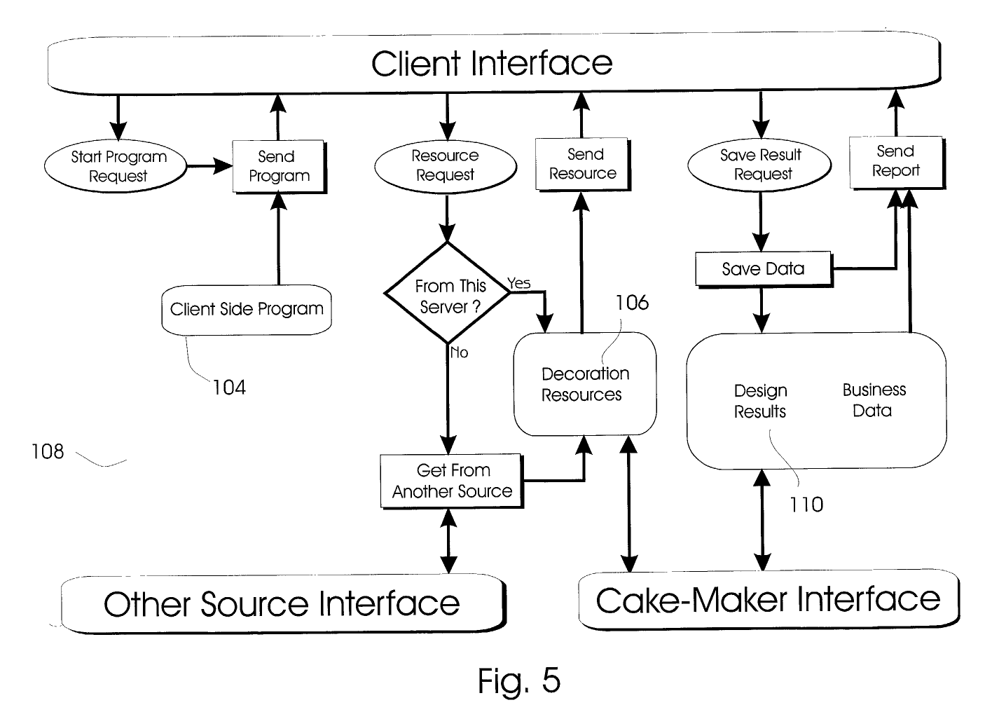

FIG. 5 shows the program running on the server. As compared to the client side design program described so far, the interface in the server side program to the client is relatively simpler. Server 108 holds a copy of client side design program 104 and all the supporting icons, images, configuration files, and so on. In response to customer's request of loading the program, server 108 sends these data out (possibly acquire unavailable data from other servers before sending). During the design stage, client computer does not really have to connect to the server all the time. The connection needs to be reestablished only if the client program 104 requests additional decoration resources, wants to save results, or wants to send other messages.

Nonetheless, the server side of the system is not entirely trivial.

Decoration resources may come from different providers. They may be priced differently by different cake-makers and for different cakes. So, a uniform format is needed to accommodate different resources, and can be easily handled in different stages of the design process.

There may be “too many” resources for customers to easily spot what 's appropriate.

Decoration resources need to be updated often to catch the “fashion”. Availability of a particular item varies by factors such as the ordering time, the deadline, and the source of the item.

Decorating skills vary among different cake-makers. Multiple factors need to be considered by customer or for customer, such as customer preference, price, distance, as well as skills. It may take quite a few tries before an appropriate cake-makers can be located.

The cost of decoration is design related. It is possible that the system cannot determine the price until getting feedback from cake makers. The system must facilitate the communication, tracking, and determination of an acceptable prices for both sides.

Many cake makers have already had online commercial sites for shopping other goods or party packages. The design system in this invention must be able to work well with those sites to provide biggest conveniences to users. For example, customers do not have to make separate payments for the designed cake and for other purchases. And customers can use the just-finished designs in electronic invitation cards sent to would-be party participates.

While it is possible to have a copy of all the required resources in a single server, A cake maker may have multiple servers in the network supporting cake design, in order to overcome network reliability problems, to increase marketing visibility, to balance server load, and so on. The system must coordinate different “mirror” servers well.

On the other hand, multiple cake makers can share a single server to save cost.

The server side program runs on every server involved. In the minimum case, it runs on a single server for a single cake maker. In the big end, it runs on computers distributed all over the network for cake makers all over the world. Customers' cake orders to different regions will be guided to different servers, to avoid congestion as well as to reach proper cake makers. Servers communicate to each other. Different tasks such as searching, billing or accounting may be handled by the same servers or by different servers. If necessary, a number of master servers can be used to maintain overall pictures of the distributed system, redirect user hits, collect sales data, and carry out other administrative tasks.

Each program execution may activate part or all of its modules. The server program contains the following major modules: Resource Manager, Server End Designing Interface, Cake Maker Module, E-Commerce Module, and Administrative Module. Server End Designing Interface is described above. Below we list functionality for the other four. Their implementation details are omitted since an average programmer will have no difficulty to realize them given existing technologies in the industry.

Resource Manager.

Store, organize and provide decoration resources. There are two types of resources. Type one resources are 2D or 3D computer representation of physical items such as cartoon characters, fruits, pre-made designs, as well as cake body and surface materials. Type two resources are model images that customers can follow or trace. For type one, the system must maintain information such as manufacturers, prices, time of availability, taste if edible, and addresses of their visual representations. For type two, the skill levels required for following, tracing, and implementation must be indicated. Both types need to be well categorized to make it easy for customers to choose for different purposes.

There are different industrial standard formats for visual representations. For example, GIF and JPG are popular formats used on the Web.

Given enough time to deadline, the availability of any item is usually not an issue since they can be made in and shipped from their manufacturers. For pressing deadlines, customer requests will be checked against quantities in inventories, and suggestions will be given on substitutions or deferred shipping.

Resources are organized by categories for easy browsing. They can also be searched by key words. The categories and key words can be based on occasion (such as birthday, anniversary, holiday, cooperate celebration, etc), favorites (such as Panda, Dinosaur, etc), locations (such as countries, vacation resorts, etc), feeling (such as happy, cheerful, sympathy, etc), and many other possibilities.

Different resource entities may have different number and types of attributes. Their database representations must take a general format that can accommodate all of them, and allow null fields for those with smaller number of attributes. A format field governs the interpretation of the formats. For example, format 102 can mean, integer field 1 contains manufacturer id, integer field 2 contains color id, integer field 3 contains taste id, integer field 4 contains material id, floating number field 1 means width, floating number field 2 means height, and so on. Format 103 can mean, string field 1 contains the address of an image, integer field 1 contains painting style id of the image, and so on. Each entity has an unique ID number, a name, and possibly a version number for internal use.

A class field is needed to define exchangeable entities. Sometimes, a cake cannot be done by one cake maker for some reason, and another cake maker does not have exactly the same items, the class field will tell what items available can be used as substitutions.

There can be multiple indexes or category trees based on different criteria mentioned above. Keywords can be associated to category nodes as well as to resource entities.

A few auxiliary tables is needed to define material, taste, color, style, and so on.

There is also a table storing price information for decoration items, possibly together with prices for other products.

Decoration entities can be updated to new version. Database modification can be done in certain system off time. If it is desired to keep system up all the time, two sets of resource database can be prepared. All update work is done in a spare set. After it is ready and from certain time on, all new customers are directed to the spare set. The previous set will be detached after the last customer on it finishes design.

Besides maintaining the resource information database as well as resource visual representations it has, the Resource Manager on each server can also talk to resource managers in other servers to get additional data. Their communication follows certain business and security protocol regarding availability, prices, and so on.

The data maintained or collected by the Resource Manager can be furnished to design program 104 through the Server End Designing Interface, as described before.

Cake Maker Module.

Contains a database that allows customer to search cake maker by geographic location, by name, by type, by price, etc. It provides an interface to register or recommend new cake makers to the network, as well as modify data for existing members. It works with Resource Manager to help cake makers in maintaining decoration resources.

Some cake makers do not have electronic connections to the network. Communication to them must be carried by other methods such as phone/fax and post office mail. And their data must be entered into the computer by third parties. On the other hand, some cake makers already have their own online commercial sites. They can still use this invention partially or fully: If they do not want to change their sites into one like this invention, they can have a second site running programs in this invention, and direct all visitors who want to have their own designs to this site. Alternatively, they can just get the client side design program and add the server side interface into their servers.

E-Commerce Module.

Takes care of customer shopping, ordering, payment, cake maker assignment, further communication between customer and cake maker if necessary, manage final product shipment, and handle various exceptions appearing in each stage.

Administrative Module.

Administrates cake maker membership. Handles exceptions such as absence of cake makers and customer complaints. Help manage marketing and other business activities. Undertake system monitoring, backup and replication.

Alternative Embodiment

Design program can be simplified to reduce size and meet simple needs. Or enhanced to be more attractive and more powerful.

In simplest case, design program can only enable drawing of lines and simple shapes and saving of the result. Frequently, it can drop one or more of these: 3D-view; Editing modes Select, Cake, Knife, Text, Tracing, Highlighter, and Assembly.

Design program can be enhanced from different aspects. It can have sound effects to amuse customer and to provide help during the design procedure. For example, whenever an operation is selected, in addition to showing its meaning in help text, design program can also read it out in voice.

As long as computer and network capacity permits, it can incorporate various special graphic user interface behaviors and painting effects that make the design procedure more like the real operations of a cake master. For example, a line or area can have 3D look of true icing or cream. The design results can be viewed from different angle, even continuously.

To make design activity more interesting to children, collaboration can be enabled. When design program is running in collaboration, design events from each customer will be sent to all the copies of design program running in front all customers in this particular collaboration. Design program will queue events from all sources and handle one by one, just as if they are from a single source. All events communication is done along path client-server-server-client. In addition to design events, customer to customer discussing messages can also be transmitted along the same path.

Operation

Customer follows these steps to design and obtain a cake.

1. Customer thinks about getting a cake for himself/herself, or sending a cake to someone, say, grandpa, granddaughter, boy friend, and so on. Customer wants to be a little more special this time. Designing a cake by oneself seems to be a good choice.

2. Customer browses to a cake customization site. This site will introduce the service, show some samples, and possibly redirect customer to another site based on, say, the location of the recipient of the cake.

3. While it is possible to order plain or pre-designed cakes from the site, and it is possible to ask for a cake based on an image uploaded from customer's computer, customer chooses to launch design program in this invention to design on the fly.

4. Design program will be downloaded from the server, if it is not already on customer's computer. During the (short) waiting, customer is presented something to read, such as drawing guidelines, design ideas, decoration resource introduction, etc.

5. Design program started. Customer can freely trigger (e.g., mouse click) various controls (Buttons, Selections, etc) in the graphics interface. The icons associated to controls gives customer hints on what they are for, e.g., icing line, poured cream, decoration flowers, etc. After a control is triggered, help text (and possibly voice) give more detailed information what to do in that situation.

6. Following help text or voice, customer acts in the drawing area. The drawing effects are shown as actions are made. Customer can undo step(s) just made, or clear the area and start over.

7. Some operations are a little more complex. For example, to trace a model image, customer need to switch to tracing mode, get a model image, trace over it, and then insert tracing result to design image. While customer can probably figure out by icons and help text/voice, a separate online help document is handy in case it is needed.

8. After customer thinks that enough have been put into drawing area, he or she can trigger saving control to store the design to the server. The server will create a unique location for it.

9. Then customer can close design program. If customer wants to modify later, design program can be launched again and previous design is loaded for modification. This is possible until the design has been sent to a cake master

10. After design is done, customer can specify additional information for the cake, such as material, siding, purpose, number of people to serve, etc.

11. Customer can give preferences on cake makers. Cake makers will be searched in the order of preferences until one appropriate is found.

12. Next customer gives contact information, shipping address if delivery is required, date and time when the cake is needed, payment information, and so on. Then customer can quit from the site.

13. The customer may get notices in a few cases: If the cake maker is not determined in design time, customer will be informed of the cake maker later. If the final price is substantially higher than estimate due to factors such as a design that is too costly to implement, customer will receive an warning or request for decision. In addition, there are notices due to exceptions such as resource not available, customer information error, etc.

14. The cake is made by the cake maker based the design.

15. The cake is transported to the recipient, either by customer pick-up or by delivery.

16. The user can download the cake image from the server, keep it, email it to other people, and/or use it for other purposes such as paint on T-shirt.

Conclusion, Ramifications, and Scope

Thus the reader will see that the online cake design system of this invention can be deployed in a computer driven network to provide customer a way to design a cake from anywhere a computer is available connecting to the network. Furthermore, the online cake design system has the additional advantages in that

It permits customer to make use of decoration resources prepared in the system;

It supports design operations that are powerful, convenient, and reflecting physical cake decoration operations.

Thus the design process is fun and controllable to customers of almost all ages and skills.

Further the design results consist of components that can be easily implemented by cake masters into real cakes.

It permits customer to search for appropriate decoration resources and design ideas by categories and by key words.

It allows customer to search cake makers by location, name, types, etc. and specify preferences on cake makers that will realize the design.

It can find a cake maker for customer that will meet requirements on skill, material, price, deadline, and so on. It will also take into account such factors as which resources are available in which cake makers.

It can handle E-Commerce activities including order, payment, shipping, etc.

It permits cake makers and decoration manufacturers to manage decoration resources, their prices, and cake orders.

It permits system administrator to maintain the whole system on an on-going basis, including vendor membership administration, system monitoring, data backup and replication, exception handling, etc.

While the above description contains many specificities, these should not be construed as limitations on the scope of the invention, but rather as an exemplification of one preferred embodiment thereof. Many other variations are possible.

Thus the scope of the invention should be determined by the appended claims and their legal equivalents, rather than by the examples given.

I claim:

1. A process of operating a network of computers to enable one or more cake makers and decoration resource producers to present decoration resources to one or more computers in said network, to enable customers from anywhere in said network to create their own cake designs, using said decoration resources in said network, and store said cake designs in said network so that cake makers can retrieve them and make cakes following said designs comprising the steps of:
(a) enabling cake makers and decoration resource producers to upload decoration resources in one or more forms from the group of color selections, shape specifications, and computer stored images of decoration items on one or more computers in said network
(b) enabling customers to start a painting interface, which mimics the real cake decoration by having, among other things, edit mode String, Cream, and Decoration, and providing further choices for each edit mode, such as strawberry, kiwi, grape, pre-designed “Happy Birthday” text, and other items for Decoration mode, and rectangle, polygon, and oval shapes for Cream mode, possibly after an (implicit) executable download from other machines to said customers' own machines
(c) having said executable, as part of said process, to initialize data storage, establish connections with one or more decoration resources, handle input events from customers, and update data storage
(d) having said executable to send design results to customer determined destination machines
(e) having programs on said destination machines to receive said design results, place them in appropriate storage, and optionally send notifications to cake makers
(f) enabling cake makers to retrieve said designs and make cakes according to said designs
